(19) United States
(12) Patent Application Publication
(10) Pub. No.: US 2012/0013716 A1
(43) Pub. Date: Jan. 19, 2012

(54) Personal 3D Video Device

(76) Inventor: Chu Wu, Taipei (TW)

(21) Appl. No.: 12/836,592

(22) Filed: Jul. 15, 2010

(51) Int. Cl. H04N 13/04

(52) U.S. Cl. 348/51; 348/E13.075

(57) ABSTRACT

The primary objective of the present invention is to provide a personal 3D video device, composed of a mount with two lens windows in the front side, a display board having a dual screen to simultaneously display visions which can be seen respectively from each lens, two lens holders contained convex lens and each attached to a lens window; and the distance between convex lens and display screen is the focal distance of the lens. This invention provides the user a spatial vision through the parallax between two focus visions from the lenses towards to the screen. Other advantages and novel features of the invention are easy-to-make, low cost for material and manufacture, and less bulky.

### BACKGOROUND OF THE INVENTION

(a) Field of the Invention

The present invention relates to a personal 3D video device for personal entertainment use.

(b) Description of the Prior Arts

The parallax from the images received from two eyes is the fundamental to build up a 3D image. Presently the use of parallax for build up 3D image, such us using 3D glasses for watching 3D pictures or movies (IMAX), is very common, although the methods of optical effects may be varied.

Among them, using polarized lens it the major measure to present today's 3D movies. This is using vertical and horizontal polarizer on right and left lens of the 3D glasses, respectively, and simultaneously projecting the polarized images to eyes to generate a clear parallax and build up a 3D image, which is called Polarization Division.

In addition, another common stereoscopy called Time Division, which is using shutter glasses to make each eye taking only the odds or even images separately from a high refresh rate display like CRT (LCD is not applied due to its low refresh rate) by the liquid crystal glasses alternately darkens (while the voltage is applied to the liquid crystal) over one eye, and then another, in synchronization with the refresh rate of the screen, while the display alternately displays different perspectives for each eye. Human brains will then process these parallax images and produce a 3D image.

Although the stereoscopies above can all generate 3D images, the cost and space requirement for equipments like glasses with CRT or projector would just limit the 3D video appliance for personal use. If the cost for equipment can't be lower, then there will be no interests for the manufacture or end-users. Furthermore, either the projector for polarizer glasses or the CRT for shutter glasses is too bulky for a personal device. Therefore, we are providing an invention of a personal 3D video device with the low manufacture cost, less space requirement and convenience.

### SUMMARY OF THE UNVENTION

To overcome the shortcomings, the present invention provides a new structure to fulfill personal requirement of a 3D video device, including the low cost and less space requirement.

The primary objective of the present invention is to provide a personal 3D video device, composed of a mount with two lens windows in the front side, a display board having a dual screen to simultaneously display visions which can be seen respectively from each lens, two lens holders contained convex lens and each attached to a lens window; and the distance between convex lens and display screen is the focal distance of the lens. This invention provides the user a spatial vision through the parallax between two focus visions from the lenses towards to the screen. Other advantages and novel features of the invention are easy-to-make, low cost for material and manufacture, and less bulky.

### DETAILED DESCRIPTION OF THE PREFERRED EMBODIMENTS

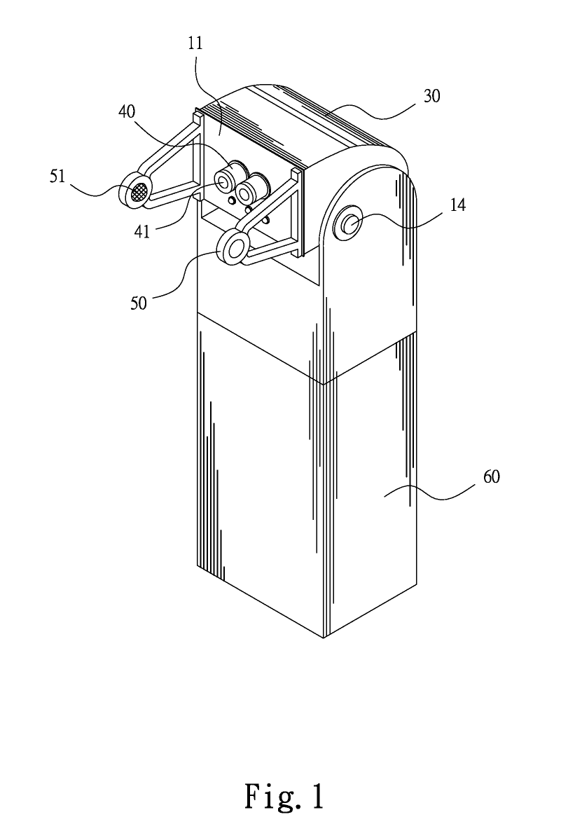

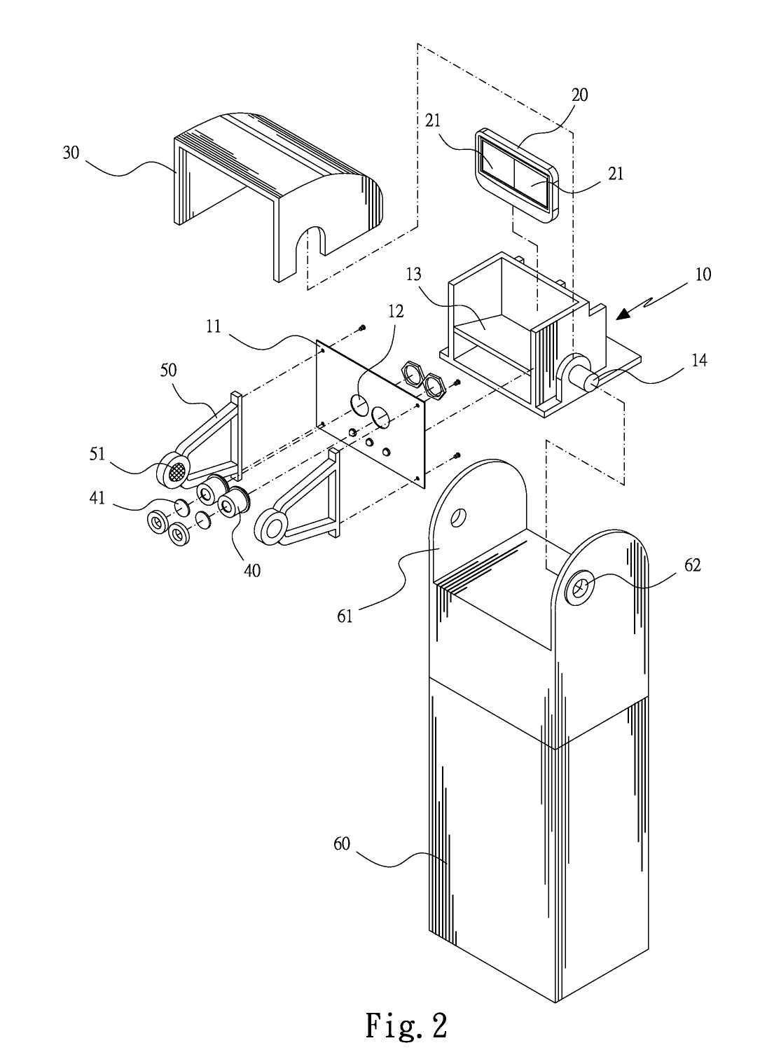

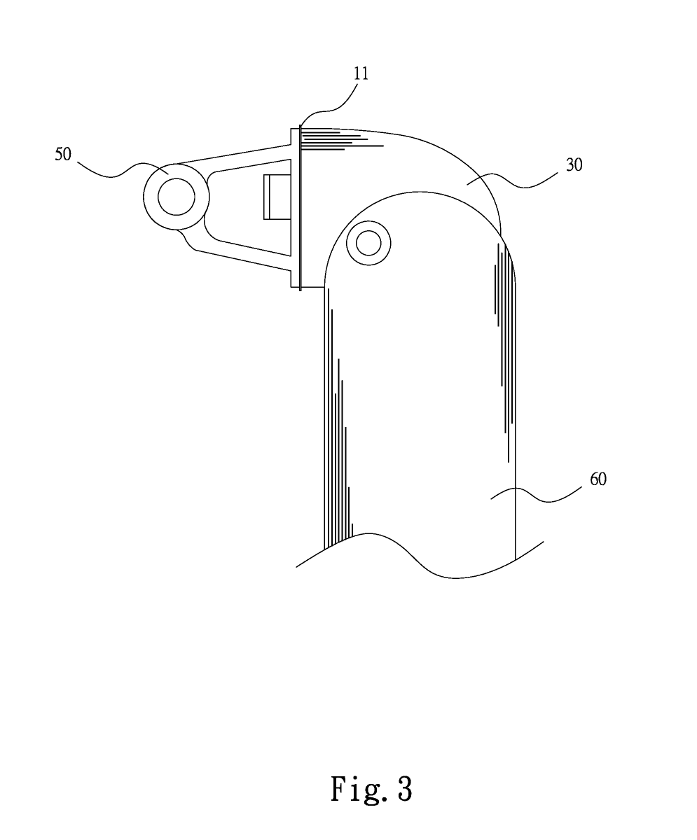

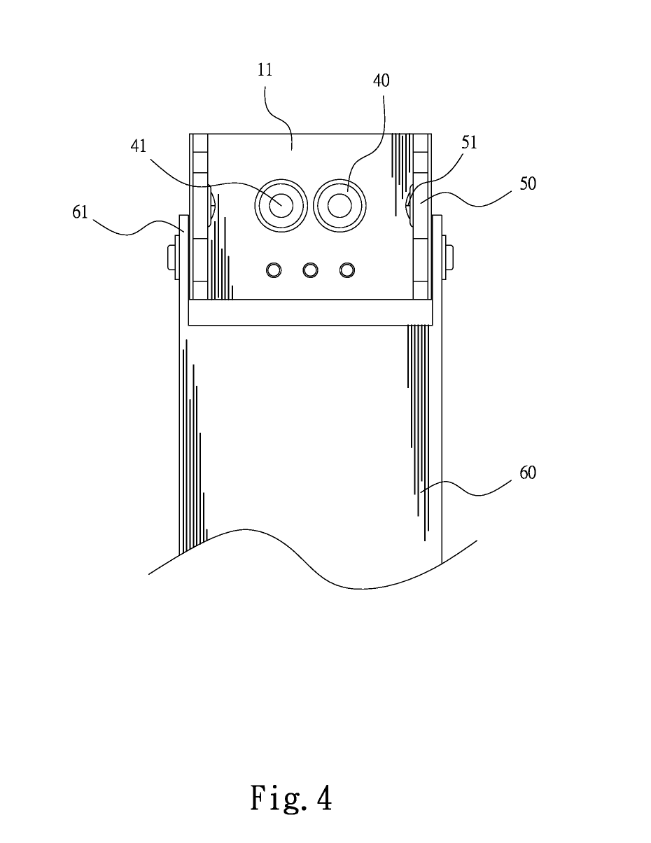

With reference to FIGS. 1 to 4, a personal 3D video device in accordance with the present invention comprises a mount (10), a display board (20), a housing (30), two lens holders (40), two handles (50), and a base (60).

The mount (10) is a frame, has an open top space, two lens windows (12) for eyes viewing in the front side (11), a base plate (13) tilt towards to the rear side, and tow bolts (14) on right and left side.

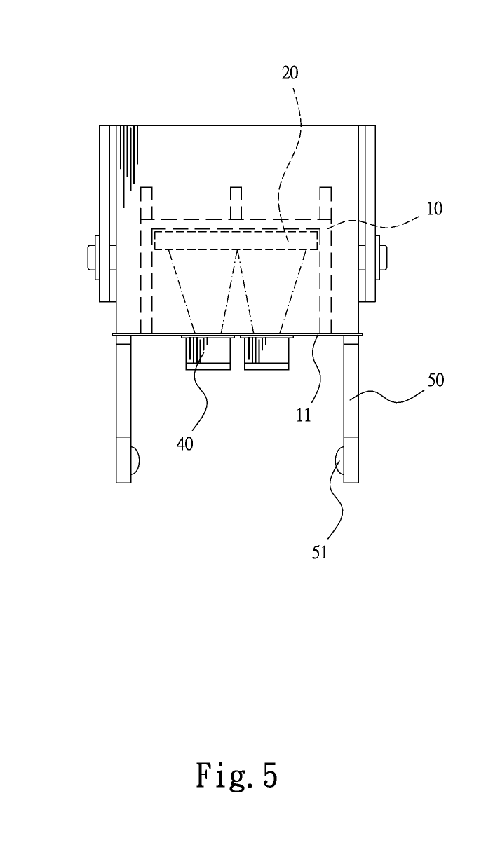

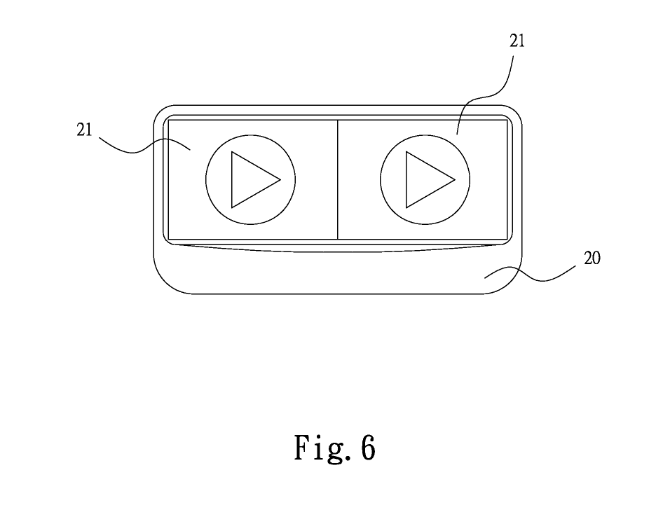

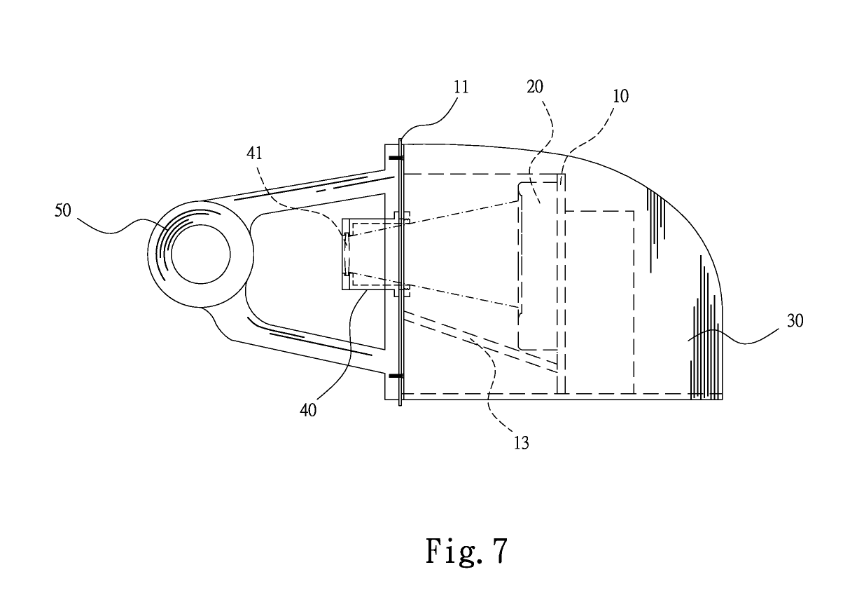

With further reference to FIGS. 5 to 7, a display board (20) is a LCD screen, attached on the rear side of the mount (10) and maintained a certain distance with the front side (11), has the other electrical components like power supply, wires, players, install device out of the rear side or side boards. The display board can be set up by the player to have a dual-screen on the LCD screen, which provides two images simultaneously on the right and left display segments (21) of the screen. Each display segment (21) is mounted in accordance with the lens window (12).

The housing (30) is mounted on the front side (11) of the mount (10), is a case to cover the mount (10) and protect the components inside.

The lens holders (40) are attached to the lens windows (12) of the mount (10). The lens holders (40) are hollowed so the user can see through the convex lens (41) inside and get a clear vision of the display segment (21) as the distance between the convex lens (41) and the display segment (21) is just the focal distance of the convex lens (41).

The handles (50) are mounted in the front side (11) of the mount (10). There will be no specification for this common used handles (50), but an audio device (51) used as speakers are mounted close to ears and on the inner wall of the handles (50).

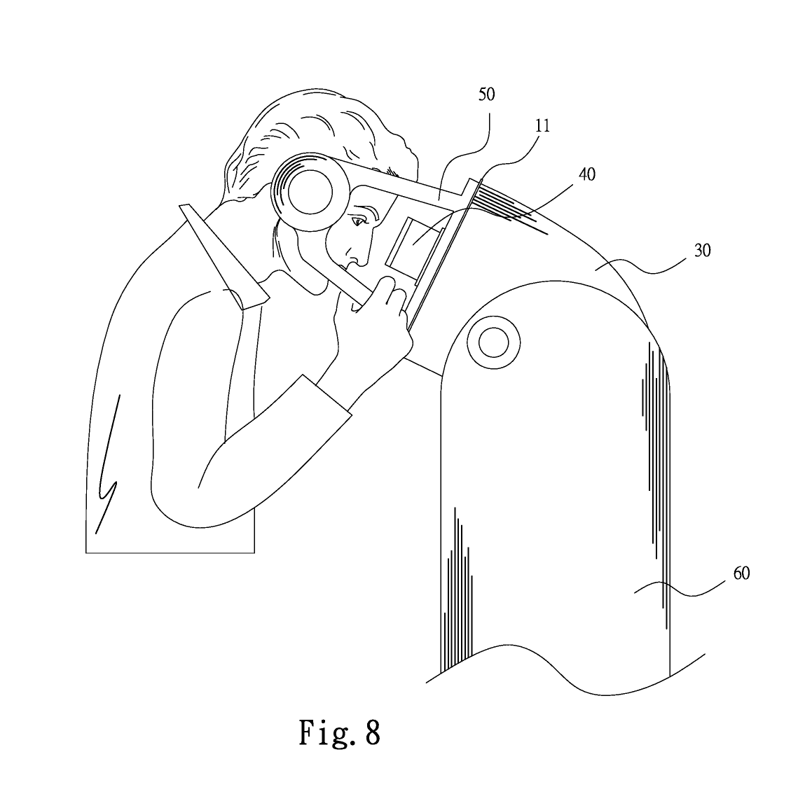

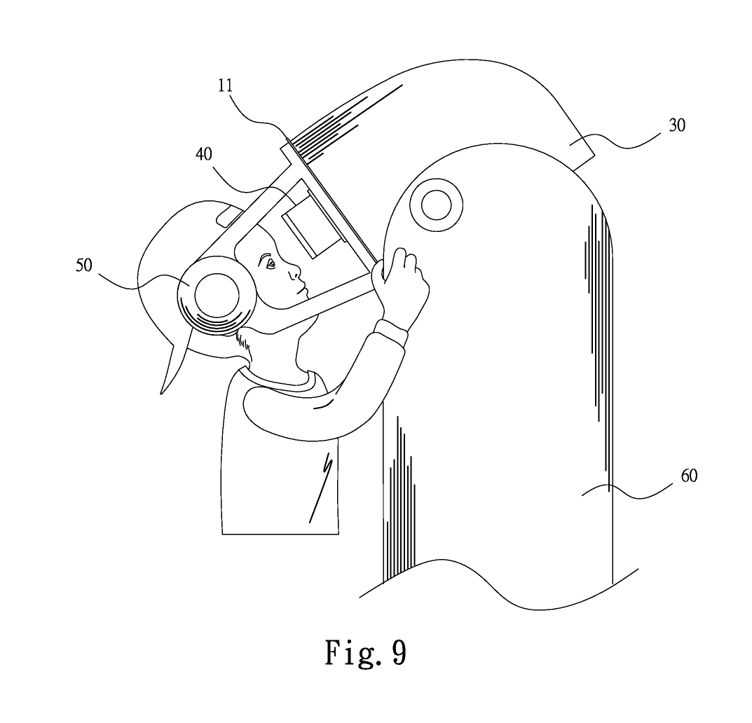

With further reference to FIGS. 8 and 9, the base (60) is a case with certain height, which is about 150 to 160 cm in our case. The holes (62) are mounted on extension side boards (61) to cope with the bolts (14) of the mount (10) and to connect the base (60) and the mount (10). The mount (10) can be tilt forward or backward on the base (60).

The practice of this device is seeing through the lens holders (40) while the video (like movies) are played on two display segments (21) of the display board (20). Because of the focus of convex lens (41), the user obtains two magnified and parallax images, which will be fused and combined to be a spatial image in brain recognition. Therefore the user gets the spatial image with 3D effects from Spatial Division. As the mount (10) can be tilt on the base (60), the users can be adults or children with different heights, just by adjusting the angle of the mount (10) through the handles (50). Therefore this device can be placed in public area. Furthermore, the audio device (51) on the handles, which is close to user's ears, will not be affected by user's height and provide a stereo-sound effect even in a noisy public area. No physical contact between the user and the audio device (51) will also benefit the public hygiene.

In addition, compared to the other present practices, this device is easy-to-make, and cost-effective in terms of the material cost and manufacturing cost. Those features will benefit the production and the promotion, with the advantage of less space requirement.

What is claimed is:

1. A personal 3D video device comprising a mount being a frame with space and having two lens windows in a front side of the mount; a display board being a LCD screen split to two display segments on a single screen so displayed simultaneously, in the space of the mount with a certain distance to the front side, and each display segment is coped with a lens window; and two lens holders attached to the lens windows in the front side of the mount, having convex lens inside with the focal distance to the display segment on the display board.

2. The personal 3D video device as claimed in claim 1,wherein the mount further has two bolts being mounted on the sides; and
Wherein the invention further comprises two handles with audio device mounted oppositely on the front side of the mount; and
A base having extension side boards with holes coped with the bolts of the mount.

3. The personal 3D video device as claimed in claim 1, wherein further comprises a removable housing being attached to the mount and abutting the front side of the mount.

4. The personal 3D video device as claimed in claim 2, wherein further comprises a removable housing being attached to the mount and abutting the front side of the mount.

5. The personal 3D video device as claimed in claim 1, wherein the mount has a base plate tilt towards a rear side of the mount; and the display board is mounted on a read board of the mount.

6. The personal 3D video device as claimed in claim 2, wherein the mount has a base plate tilt towards a rear side of the mount; and the display board is mounted on a read board of the mount.

7. The personal 3D video device as claimed in claim 2, the audio device is a speaker.

8. A personal 3D video device for users with different height comprising a mount being a frame with space, having two lens windows in a front side of the mount and has two bolts being mounted on the sides;
Two handles with audio device mounted oppositely on the front side of the mount; and
A base having extension side boards with holes coped with the bolts of the mount.
